(19) United States
(12) Patent Application Publication
(10) Pub. No.: US 2026/0144245 A1
(43) Pub. Date: May 28, 2026

(54) Bite-Indicating Rod Holder

(71) Applicant: Kenneth Allen Anderson, JR., Grand Rapids, MN (US)

(72) Inventor: Kenneth Allen Anderson, JR., Grand Rapids, MN (US)

(21) Appl. No.: 19/344,498

(22) Filed: Sep. 29, 2025

Related U.S. Application Data
(60) Provisional application No. 63/700,211, filed on Sep. 27, 2024.

(51) Int. Cl. A01K 97/12; A01K 87/00; F16B 2/22

(52) U.S. Cl. CPC A01K 97/125; A01K 87/007; F16B 2/22

(57) ABSTRACT

A bite-indicating rod holder is used to hold a fishing rod in place without supervision and automatically alerts a nearby user with an audible and/or visual alarm that a fish is caught on the line of the fishing rod. The bite-indicating rod holder includes an elongated platform, a rod clamp, a butt stabilizer, an anchoring mechanism, an alarm system, and a line-based trigger.

The current application claims a priority to the U.S. provisional patent application Ser. No. 63/700,211 filed on Sep. 27, 2024. The current application is filed on Sep. 29, 2025, while Sep. 27, 2025 was on a weekend.

### FIELD OF THE INVENTION

The present invention generally relates to a fishing rod holder. More specifically, the present invention is a device that secures a fishing rod and produces an indicating alert when a fish is on the line.

### BACKGROUND OF THE INVENTION

A fishing rod holder is a device that securely holds a fishing rod in place that enables a user to fish hands free. Fishing rod holders are designed with various materials, shapes and designs, depending on the environment and type of fishing. Fishing rod holders are designed to keep the rod stable while a user waits for a fish to bite. Many current fishing rods simply secure the fishing rod and rely on the user being vigilant and noticing the fishing rod being pulled by a fish once hooked. This causes many users to miss out on catching fish due to not paying attention or being located in a position without a direct line of sight to the fishing rod.

Therefore, an objective of the present invention is to provide users with an alarm when a fish is hooked on the fishing line, to help increase the amount of catches a user gets over time. The present invention intends to provide users with a device that properly secures a fishing rod. In order to accomplish that, a preferred embodiment of the present invention comprises a clamping arm assembly, a base plate, a rod holder assembly, a rod but stabilizer, an alarm system, and a trigger arm assembly. Thus, the present invention is a fish bite indicating rod holder that alerts the user when a fish is hooked on the fishing line.

### SUMMARY OF THE INVENTION

The present invention is a device that holds a fishing rod in a secure position allowing a user to fish hands free. The present invention seeks to provide users with a device that indicates a fish bite audibly and visually without alerting the fish. In order to accomplish this, the present invention comprises a clamping arm assembly that secures the present invention to various external objects. The rod holder assembly and the rod butt stabilizer secure the fishing rod in place. Further, the alarm system provides an alert for the user when a fish has bitten the fishing line. Additionally, the trigger arm assembly is the mechanical switch that turns the alarm system on and off once a fish has bitten the fishing line. Thus, the present invention is a fish bite indicating rod holder that alerts the user when a fish is hooked on the fishing line.

### BRIEF DESCRIPTION OF THE DRAWINGS

FIG. 1 is a front-right-top perspective view of the present invention, wherein a fishing line is hitched onto the present invention.

FIG. 2 is a front-right-bottom perspective view of the present invention thereof.

FIG. 3 is a rear-left-top perspective view of the present invention thereof.

FIG. 4 is a rear-left-bottom perspective view of the present invention thereof.

FIG. 5 is a front-right-top perspective view of the present invention, wherein a fishing line is hitched onto the present invention, and wherein a fishing rod is held by the present invention.

FIG. 6 is a front-right-bottom perspective view of the present invention thereof.

FIG. 7 is a front-right-top perspective view of the present invention, wherein a fishing line has been releases from the present invention, and wherein a fishing rod is held by the present invention.

FIG. 8 is a front-right-bottom perspective view of the present invention thereof.

FIG. 9 is a schematic diagram of the electronic connections within the alarm system of the present invention.

FIG. 10 is a schematic diagram of the electrical connections within the alarm system of the present invention.

### DETAILED DESCRIPTION OF THE INVENTION

All illustrations of the drawings are for the purpose of describing selected versions of the present invention and are not intended to limit the scope of the present invention.

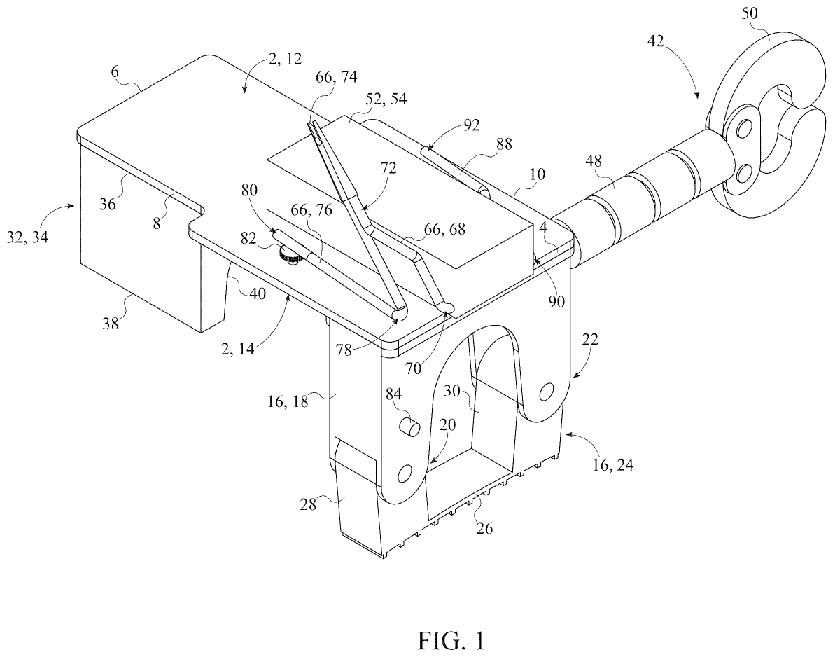

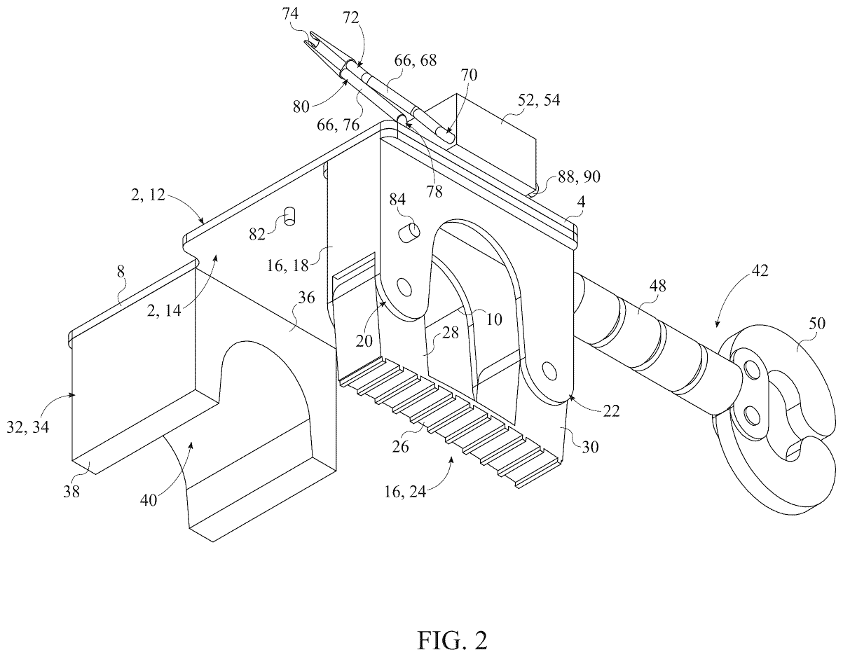

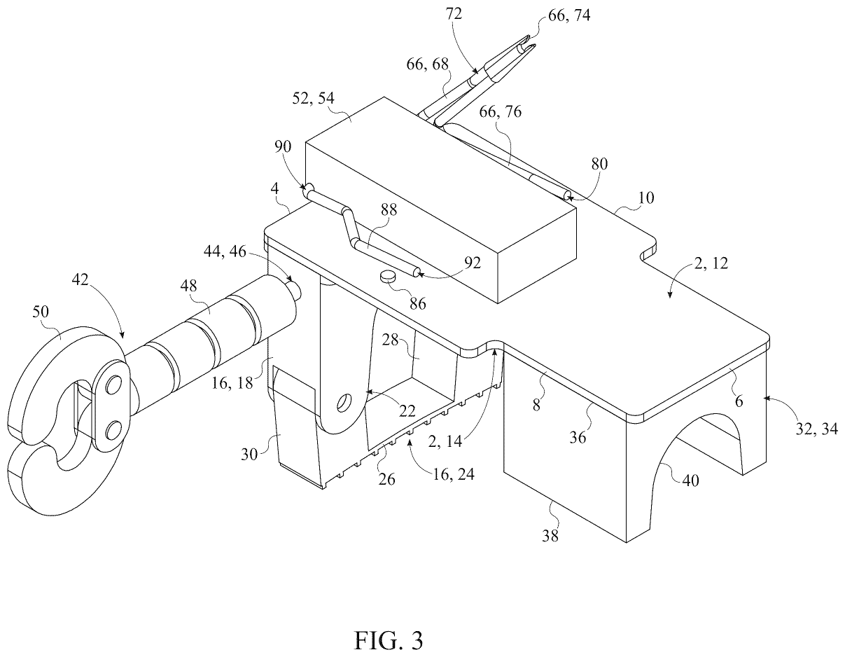

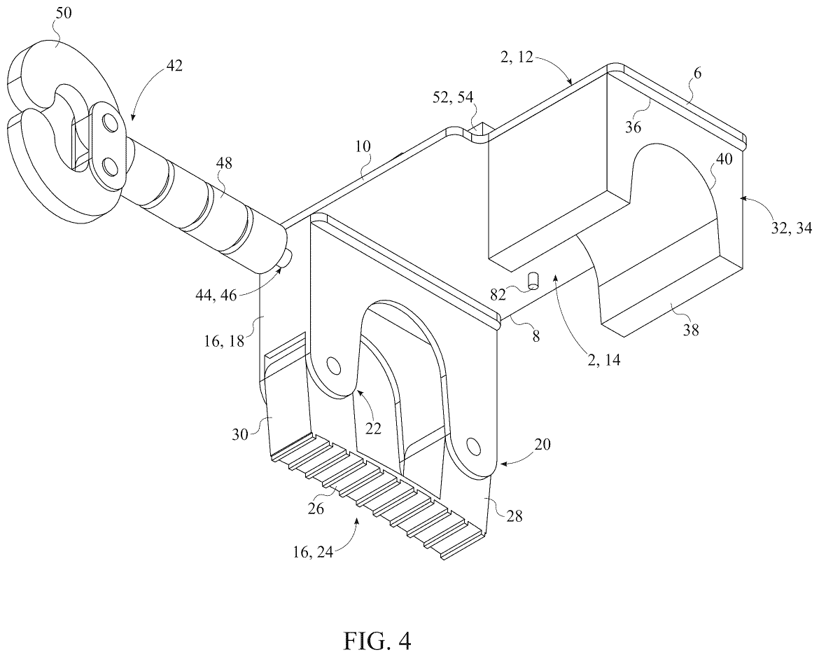

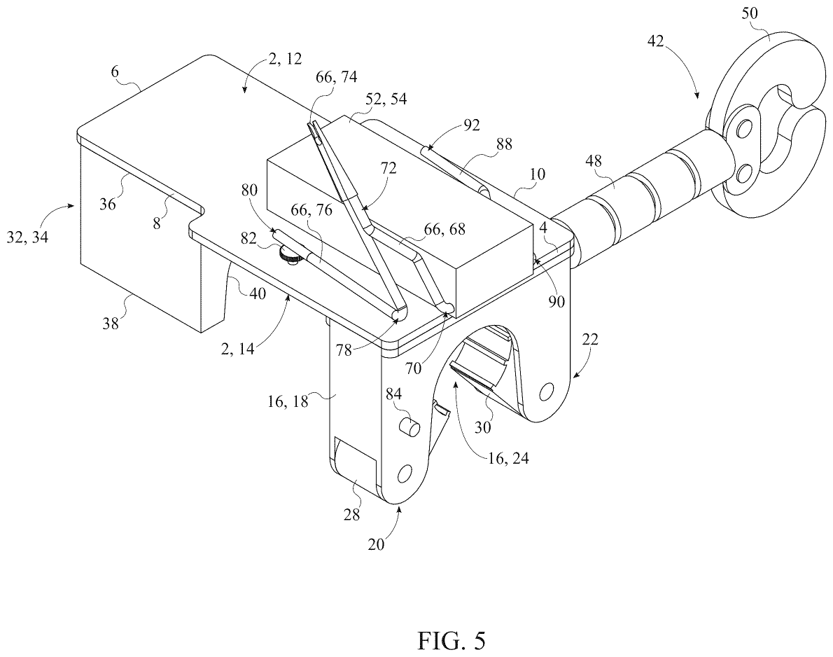

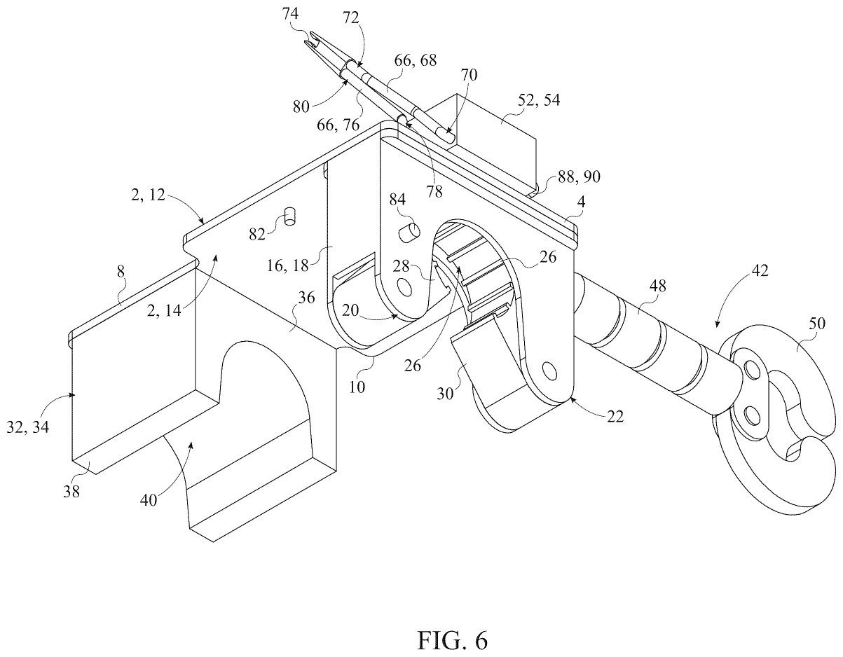

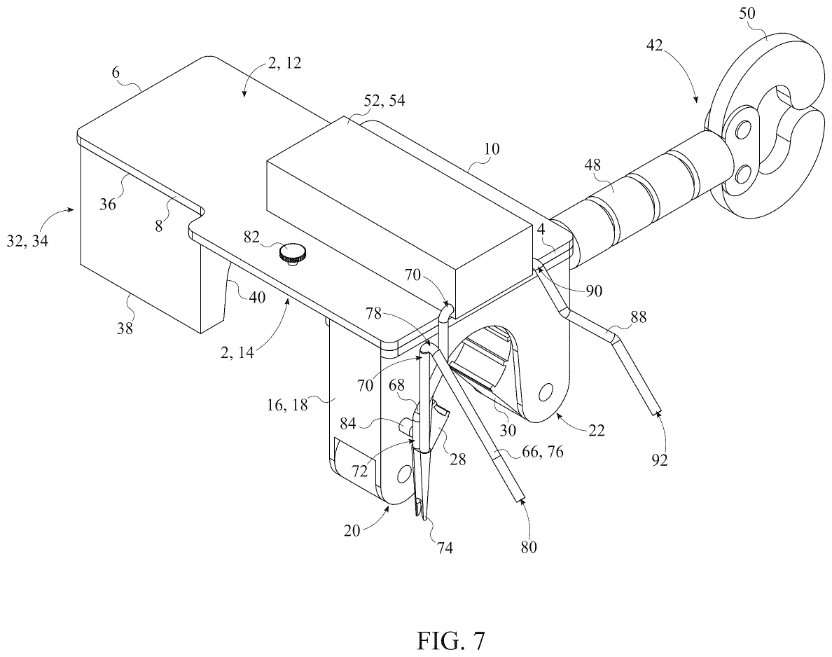

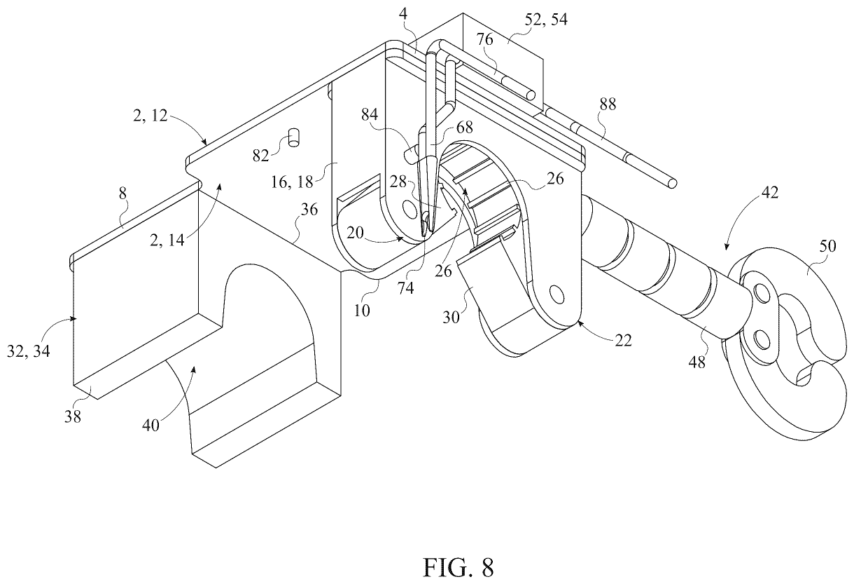

The present invention is a bite-indicating rod holder that is used to hold a fishing rod in place without supervision but still would be able to audibly and/or visually notify a user that a fish is caught on a line of the fishing rod. Thus, as can be seen in FIGS. 1 through 8, the present invention comprises an elongated platform 2, a rod clamp 16, a butt stabilizer 32, an anchoring mechanism 42, an alarm system 52, and a line-based trigger 66. The elongated platform 2 is a rigid structural body of the present invention and is used as a base to connect the other components of the present invention together. The rod clamp 16 is used to laterally grasp a handle of a fishing rod, while the butt stabilizer 32 is used to securely support an end of the fishing rod. The anchoring mechanism 42 allows the present invention to mount a fishing rod to a specific location in a specific orientation. The line-based trigger 66 is used to detect a fish being caught on a line of a fishing rod held in place by the present invention, while the alarm system 52 is an electronic device that outputs an audible and/or visual alarm once the line-based trigger 66 detects the fish.

In order to better define the arrangement of the aforementioned components, the elongated platform 2 comprises a first widthwise edge 4, a second widthwise edge 6, a first lengthwise edge 8, a second lengthwise edge 10, a top platform face 12, and a bottom platform face 14. The top platform face 12 and the bottom platform face 14 are surfaces positioned opposite to each other about the elongated platform 2. The first lengthwise edge 8 and the second lengthwise edge 10 are two edges positioned opposite to each other across the elongated platform 2, and the first widthwise edge 4 and the second widthwise edge 6 are the other two edges positioned opposite to each other across the elongated platform 2. The first widthwise edge 4 and the second widthwise edge 6 are also the opposing ends of the elongated platform 2, and, thus, the first lengthwise edge 8 and the second lengthwise edge 10 are positioned in between the first widthwise edge 4 and the second widthwise edge 6.

The general configuration of the aforementioned components allows the present invention to efficiently and effectively hold a fishing rod in a specific location and a specific orientation while still providing an audible and/or visual notification if a fish is caught on a line of the fishing rod. The rod clamp 16 is mounted onto the bottom platform face 14, adjacent to the first widthwise edge 4, which allows the present invention to laterally grasp a handle of a fishing rod at one end of the elongated platform 2. The butt stabilizer 32 is mounted onto the bottom platform face 14, adjacent to the second widthwise edge 6, which allows the present invention to securely support an end of a fishing rod at the other end of the elongated platform 2. This arrangement between the rod clamp 16, the butt stabilizer 32, and the elongated platform 2 allows a rod-orienting direction of the rod clamp 16 to be positioned parallel to a platform length of the elongated platform 2. The anchoring mechanism 42 is laterally mounted to the rod clamp 16, adjacent to the first lengthwise edge 8, so that the anchoring mechanism 42 does not mechanically interfere with a fishing rod being held in place by the rod clamp 16 and the butt stabilizer 32. The alarm system 52 is mounted onto the top platform face 12, adjacent to the to the first widthwise edge 4, which prevents the alarm system 52 from occupying the same space as a fishing rod being held in place by the rod clamp 16 and the butt stabilizer 32 and allows the line-based trigger 66 to be operatively mounted to the alarm system 52 in order to activate the alarm system 52. The line-based trigger 66 is positioned adjacent to the second lengthwise edge 10 so that the functionality of line-based trigger 66 is not mechanically interfered with a fishing rod being held in place by the rod clamp 16 and the butt stabilizer 32 or the anchoring mechanism 42 being attached to a situated fixture (e.g., a wall, a railing, a table, etc.).

As can be seen in FIGS. 1 through 8, the rod clamp 16 may comprise a U-shaped rigid frame 18 and an elastic cam saddle 24. The U-shaped rigid frame 18 provides structural support for the elastic cam saddle 24. The U-shaped rigid frame 18 comprising a first free end 20 and a second free end 22, which are the ends of a U-shaped object oriented in the same direction. The U-shaped rigid frame 18 is connected onto the bottom platform face 14, adjacent to the first widthwise edge 4, and the first free end 20 and the second free end 22 are positioned offset from the bottom platform face 14 so that the U-shaped rigid frame 18 is able to laterally brace a fishing rod towards the elongated platform 2. Moreover, the elastic cam saddle 24 is used to receive and frictionally grasp the lateral surface for a handle of a fishing rod. The elastic cam saddle 24 comprises a flexible saddle strip 26, a first flexible protrusion 28, and a second flexible protrusion 30. The flexible saddle strip 26 receives a handle of a fishing rod and laterally wraps about the handle of the fishing rod in order to frictionally grasp the handle of the fishing rod. The first flexible protrusion 28 and the second flexible protrusion 30 are connected onto the flexible saddle strip 26 and are positioned opposite to each other along the flexible saddle strip 26. This arrangement between the first flexible protrusion 28, the second flexible protrusion 30, and the flexible saddle strip 26 allows the first flexible protrusion 28 and the second flexible protrusion 30 to hold the flexible saddle strip 26 in a flat configuration if a handle of a fishing rod is not engaged with the flexible saddle strip 26. This arrangement between the first flexible protrusion 28, the second flexible protrusion 30, and the flexible saddle strip 26 also allows the first flexible protrusion 28 and the second flexible protrusion 30 to hold the flexible saddle strip 26 in a curved configuration if a handle of a fishing rod is engaged with the flexible saddle strip 26 as the flexible saddle strip 26 laterally wraps around the handle of the fishing rod. The first flexible protrusion 28 is rotatably connected to the first free end 20, and the second flexible protrusion 30 being rotatably connected to the second free end 22 so that the first flexible protrusion 28 and the second flexible protrusion 30 are able to rotate towards each other as a handle of a fishing rod engages the flexible saddle strip 26 and pushes the flexible saddle strip 26 into the U-shaped rigid frame 18.

As can be seen in FIGS. 1 through 8, the butt stabilizer 32 may comprise a stabilizer body 34 and a butt-bracing crevice 40. The stabilizer body 34 is preferably made of an elastic compressible material (e.g., Styrofoam) and is used to brace, cushion, and situate an end of a fishing rod (i.e., the end near a handle of the fishing rod). The stabilizer body 34 comprises a top body side 36 and a bottom body side 38, which are opposing sides of the stabilizer body 34. The top body side 36 is connected onto the bottom platform face 14, adjacent to the second widthwise edge 6, in order to secure the butt stabilizer 32 at a location offset from the rod clamp 16. The butt-bracing crevice 40 is used to receive and lock in place an end of the fishing rod. The butt-bracing crevice 40 traverses from the bottom body side 38 into the stabilizer body 34, which allows the butt-bracing crevice 40 to be in a more colinear positioning with the rod clamp 16. The butt-bracing crevice 40 is also positioned parallel to the rod-orienting direction of the rod clamp 16 so that a fishing rod can easily supported in a straight configuration from the butt-bracing crevice 40 to the rod clamp 16.

As can be seen in FIGS. 1 through 8, the line-based trigger 66 may comprise a trigger lever 68 and a line-bracing notch 74. The trigger lever 68 is pulled by a fish caught on a line of a fishing rod in order to activate the alarm system 52, and the line-bracing notch 74 allows the line of a fishing rod to be hitched onto the trigger lever 68. The trigger lever 68 comprises a proximal lever end 70 and a distal lever end 72, which are opposing ends of the trigger lever 68. The proximal lever end 70 is rotatably connected to the alarm system 52 about a trigger rotation axis, which allows the trigger lever 68 to preferably connect to a rotary switch of the alarm system 52 and to preferably activate the alarm system 52 through the rotary switch. The line-bracing notch 74 is integrated into the distal lever end 72 so that the trigger lever 68 can be pulled by a line of a fishing rod hitched onto the line-bracing notch 74. The line-bracing notch 74 and the trigger rotation axis are positioned parallel to the rod-orienting direction of the rod clamp 16. This arrangement between the rod clamp 16 and the line-based trigger 66 allows a line of a fishing rod to traverse perpendicular to the fishing rod from its spool up to the line-bracing notch 74 and to then traverse parallel to fishing rod after the line-bracing notch 74. This arrangement between the rod clamp 16 and the line-based trigger 66 also allows a tug on a line of a fishing rod to pull down the trigger lever 68 and to consequently activate the alarm system 52.

The line-based trigger 66 may further comprise a stopping arm 76 and a height-adjustable stop 82. The stopping arm 76 and the height-adjustable stop 82 are used in unison to adjust the tension in a line of a fishing rod hitched onto the line-bracing notch 74. The stopping arm 76 may comprise a proximal arm end 78 and a distal arm end 80, which are opposing ends of the stopping arm 76. The proximal arm end 78 is laterally connected to the trigger lever 68, adjacent to the proximal lever end 70, so that the stopping arm 76 is able to follow the angular movement of the trigger lever 68. The stopping arm 76 is oriented at an acute angle with the trigger lever 68, which allows the stopping arm 76 to stop the angular movement of the trigger lever 68 at the desired angle. Moreover, the height-adjustable stop 82 is preferably a screw and is integrated through the elongated platform 2. The height-adjustable stop 82 is also positioned along the second lengthwise edge 10, offset from the first widthwise edge 4. This arrangement between the stopping arm 76, the height-adjustable stop 82, and the elongated platform 2 allows the height-adjustable stop 82 to be operatively coupled to the distal arm end 80 so that the height-adjustable stop 82 can be used to restrict movement of the distal arm end 80 and to consequently adjust a line tension with the trigger lever 68. As one example, if the height-adjustable stop 82 is adjusted for a shorter height protruding from the top platform face 12, then the stopping arm 76 and the trigger lever 68 are configured for a harder trigger pull by a line of a fishing rod hitched onto the line-bracing notch 74. As an alternative example, if the height-adjustable stop 82 is adjusted for a taller height protruding from the top platform face 12, then the stopping arm 76 and the trigger lever 68 are configured for a lighter trigger pull by a line of a fishing rod hitched onto the line-bracing notch 74.

The line-based trigger 66 may further comprise a magnetic lever catch 86, which is used to magnetically catch the trigger lever 68 as a fish caught on a line of a fishing rod may pull the trigger lever 68 too hard causing the trigger lever 68 to bounce back and turn off the alarm system 52. Thus, the trigger lever 68 needs to be made of a ferromagnetic material. The magnetic lever catch 86 is connected onto the rod clamp 16, adjacent to the trigger lever 68, and is positioned opposite to the butt stabilizer 32 about the rod clamp 16 so that the magnetic lever catch 86 is properly positioned to magnetically attach the trigger lever 68 to the rod clamp 16 and consequently prevents the alarm system 52 from accidentally turning off.

The present invention may further comprise a magnetic latch catch 86 and an elongated latch 88, which are used in unison to keep the alarm system 52 from accidentally turning on. The elongated latch 88 comprises a proximal latch end 90 and a distal latch end 92, which are opposing ends of the elongated latch 88. The elongated latch 88 needs to be made of a ferromagnetic material so that the magnetic latch catch 86 is able to magnetically secure the elongated latch 88 in place against the top platform face 12. The magnetic latch catch 86 and the elongated latch 88 are positioned adjacent to the second lengthwise edge 10 in order to prevent any mechanical interference between the movement of the trigger lever 68 and the movement of elongated latch 88. The proximal latch end 90 is torsionally connected to the proximal lever end 70 through the alarm system 52 so that, if the trigger lever 68 is pulled by a fish caught a line of a fishing rod, then the elongated latch 88 moves in unison with the trigger lever 68 in order to turn on the alarm system 52. The magnetic latch catch 86 is connected onto the top platform face 12, offset from the proximal latch end 90, which allows the magnetic latch catch 86 to magnetically secure the distal latch end 92 against the top platform face 12 and to consequently keep the alarm system 52 from being turned on.

As can be seen in FIGS. 1 through 8, the anchoring mechanism 42 may comprise a female fastener 44, a male fastener 46, a bendable arm 48, and a support clamp 50. The support clamp 50 is used to mount the present invention to a structural fixture (e.g., a railing, a wall, a table, etc.). The bendable arm 48 allows the present invention to mount a fishing rod with a specific location and a specific orientation. The bendable arm 48 is preferably a series of interconnected ball-and-socket joints. The female fastener 44 and the male fastener 46 allow the anchoring mechanism 42 to be detachably attached to the rod clamp 16. Thus, the support clamp 50 is terminally mounted to the bendable arm 48, while the male fastener 46 is terminally mounted to the bendable arm 48, opposite to the support clamp 50, which allow a fishing rod held by the present invention to be held offset from a structural fixture that is mounting the present invention in place. For example, if the present invention is mounted a fishing rod to a railing, the anchoring mechanism 42 would position the fishing rod offset from the railing so that the railing does not obstruct the use of the fishing rod. The female fastener 44 is laterally integrated into the rod clamp 16, adjacent to the first lengthwise edge 8, and the male fastener 46 is threadably engaged into the female fastener 44, which secures the anchoring mechanism 42 to the rod clamp 16 without occupying the same space as a fishing rod or the line-based trigger 66.

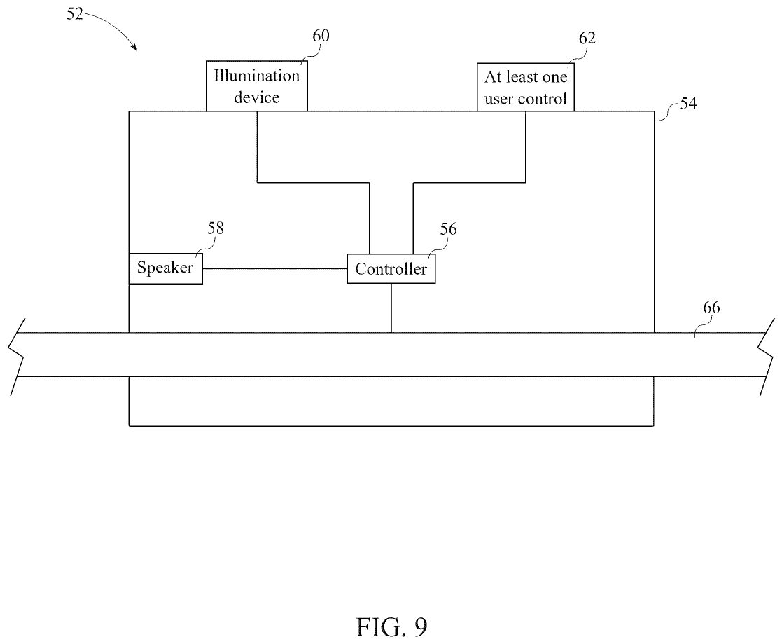

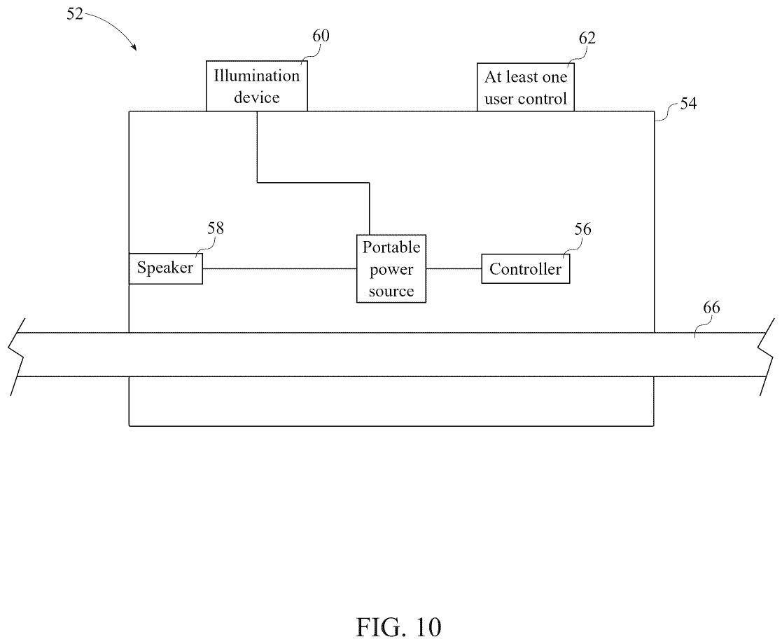

As can be seen in FIGS. 1 through 10, the alarm system 52 may comprise a housing 54, a controller 56, a speaker 58, an illumination device 60, at least one user control 62, and a portable power source 64. The housing 54 provides a structural enclosure for the other components of the alarm system 52. The controller 56 is used to manage commands and communication between the other components of the alarm system 52. The speaker 58 is used to output the audible portion of an alarm, while the illumination device 60 is used to output the visual portion of the alarm. The at least one user control 62 allows a user to control different functional aspects of the alarm system 52. The at least one user control 62 includes, but is not limited to, a volume button. The portable power source 64 is preferably a battery and is used to provide electrical power to the electronic components of the alarm system 52. Thus, the controller 56, the speaker 58, and the portable power source 64 are mounted within the housing 54, while the at least one user control 62 and the illumination device 60 are externally mounted to the housing 54. The line-based trigger 66 traverses into the housing 54 so that the line-based trigger 66 is able to activate the alarm system 52. The speaker 58, the illumination device 60, the at least one user control 62, and the line-based trigger 66 are electronically connected to the controller 56 so that the controller 56 is then able to manage the different functionalities amongst these components. The speaker 58, the illumination device 60, and the controller 56 are electrically connected to the portable power source 64 so that the portable power source 64 is able to provide electrical power to these components.

Although the invention has been explained in relation to its preferred embodiment, it is to be understood that many other possible modifications and variations can be made without departing from the spirit and scope of the invention as hereinafter claimed.

What is claimed is:

1. A bite-indicating rod holder comprising:
an elongated platform;
a rod clamp;
a butt stabilizer;
an anchoring mechanism;
an alarm system;
a line-based trigger;
the elongated platform comprising a first widthwise edge, a second widthwise edge, a first lengthwise edge, a second lengthwise edge, a top platform face, and a bottom platform face;
the rod clamp being mounted onto the bottom platform face, adjacent to the first widthwise edge;
a rod-orienting direction of the rod clamp being positioned parallel to a platform length of the elongated platform;
the butt stabilizer being mounted onto the bottom platform face, adjacent to the second widthwise edge;
the anchoring mechanism being laterally mounted to the rod clamp, adjacent to the first lengthwise edge;
the alarm system being mounted onto the top platform face, adjacent to the to the first widthwise edge;
the line-based trigger being operatively mounted to the alarm system, wherein the line-based trigger is used to activate the alarm system; and
the line-based trigger being positioned adjacent to the second lengthwise edge.

2. The bite-indicating rod holder as claimed in claim 1 comprising:
the rod clamp comprising a U-shaped rigid frame and an elastic cam saddle;
the U-shaped rigid frame comprising a first free end and a second free end;
the elastic cam saddle comprising a flexible saddle strip, a first flexible protrusion, and a second flexible protrusion;
the U-shaped rigid frame being connected onto the bottom platform face, adjacent to the first widthwise edge;
the first free end and the second free end being positioned offset from the bottom platform face;
the first flexible protrusion and the second flexible protrusion being connected onto the flexible saddle strip;
the first flexible protrusion and the second flexible protrusion being positioned opposite to each other along the flexible saddle strip;
the first flexible protrusion being rotatably connected to the first free end; and
the second flexible protrusion being rotatably connected to the second free end.

3. The bite-indicating rod holder as claimed in claim 1 comprising:
the butt stabilizer comprising a stabilizer body and a butt-bracing crevice;
the stabilizer body comprising a top body side and a bottom body side;
the top body side being connected onto the bottom platform face, adjacent to the second widthwise edge;
the butt-bracing crevice traversing from the bottom body side into the stabilizer body; and
the butt-bracing crevice being positioned parallel to the rod-orienting direction of the rod clamp.

4. The bite-indicating rod holder as claimed in claim 3, wherein the stabilizer body is made of an elastic compressible material.

5. The bite-indicating rod holder as claimed in claim 1 comprising:
the line-based trigger comprising a trigger lever and a line-bracing notch;
the trigger lever comprising a proximal lever end and a distal lever end;
the proximal lever end being rotatably connected to the alarm system about a trigger rotation axis;
the line-bracing notch being integrated into the distal lever end; and
the line-bracing notch and the trigger rotation axis being positioned perpendicular to the rod-orienting direction of the rod clamp.

6. The bite-indicating rod holder as claimed in claim 5 comprising:
the line-based trigger further comprising a stopping arm and a height-adjustable stop;
the stopping arm comprising a proximal arm end and a distal arm end;
the proximal arm end being laterally connected to the trigger lever, adjacent to the proximal lever end;
the stopping arm being oriented at an acute angle with the trigger lever;
the height-adjustable stop being integrated through the elongated platform;
the height-adjustable stop being positioned along the second lengthwise edge, offset from the first widthwise edge; and
the height-adjustable stop being operatively coupled to the distal arm end, wherein the highlight-adjustable stop is used to restrict movement of the distal arm end and to consequently adjust a line tension with the trigger lever.

7. The bite-indicating rod holder as claimed in claim 5 comprising:
the line-based trigger further comprising a magnetic lever catch;
the trigger lever being made of a ferromagnetic material;
the magnetic lever catch being connected onto the rod clamp, adjacent to the trigger lever; and
the magnetic lever catch being positioned opposite to the butt stabilizer about the rod clamp.

8. The bite-indicating rod holder as claimed in claim 5 comprising:
a magnetic latch catch;
an elongated latch;
the elongated latch comprising a proximal latch end and a distal latch end;
the elongated latch being made of a ferromagnetic material;
the magnetic latch catch and the elongated latch being positioned adjacent to the second lengthwise edge;
the proximal latch end being torsionally connected to the proximal lever end through the alarm system; and
the magnetic latch catch being connected onto the top platform face, offset from the proximal latch end.

9. The bite-indicating rod holder as claimed in claim 1 comprising:
the anchoring mechanism comprising a female fastener, a male fastener, a bendable arm, and a support clamp;
the support clamp being terminally mounted to the bendable arm;
the male fastener being terminally mounted to the bendable arm, opposite to the support clamp;
the female fastener being laterally integrated into the rod clamp, adjacent to the first lengthwise edge; and
the male fastener being threadably engaged into the female fastener.

10. The bite-indicating rod holder as claimed in claim 9, wherein the bendable arm is a series of interconnected ball-and-socket joints.

11. The bite-indicating rod holder as claimed in claim 1 comprising:
the alarm system comprising a housing, a controller, a speaker, an illumination device, at least one user control, and a portable power source;
the controller, the speaker, and the portable power source being mounted within the housing;
the at least one user control and the illumination device being externally mounted to the housing;
the line-based trigger traversing into the housing;
the speaker, the illumination device, the at least one user control, and the line-based trigger being electronically connected to the controller; and
the speaker, the illumination device, and the controller being electrically connected to the portable power source.

12. A bite-indicating rod holder comprising:
an elongated platform;
a rod clamp;
a butt stabilizer;
an anchoring mechanism;
an alarm system;
a line-based trigger;
the elongated platform comprising a first widthwise edge, a second widthwise edge, a first lengthwise edge, a second lengthwise edge, a top platform face, and a bottom platform face;
the line-based trigger comprising a trigger lever and a line-bracing notch;
the trigger lever comprising a proximal lever end and a distal lever end;
the rod clamp being mounted onto the bottom platform face, adjacent to the first widthwise edge;
a rod-orienting direction of the rod clamp being positioned parallel to a platform length of the elongated platform;
the butt stabilizer being mounted onto the bottom platform face, adjacent to the second widthwise edge;
the anchoring mechanism being laterally mounted to the rod clamp, adjacent to the first lengthwise edge;
the alarm system being mounted onto the top platform face, adjacent to the to the first widthwise edge;
the line-based trigger being operatively mounted to the alarm system, wherein the line-based trigger is used to activate the alarm system;
the line-based trigger being positioned adjacent to the second lengthwise edge;
the proximal lever end being rotatably connected to the alarm system about a trigger rotation axis;
the line-bracing notch being integrated into the distal lever end; and
the line-bracing notch and the trigger rotation axis being positioned perpendicular to the rod-orienting direction of the rod clamp.

13. The bite-indicating rod holder as claimed in claim 12 comprising:
the rod clamp comprising a U-shaped rigid frame and an elastic cam saddle;
the U-shaped rigid frame comprising a first free end and a second free end;
the elastic cam saddle comprising a flexible saddle strip, a first flexible protrusion, and a second flexible protrusion;
the U-shaped rigid frame being connected onto the bottom platform face, adjacent to the first widthwise edge;
the first free end and the second free end being positioned offset from the bottom platform face;
the first flexible protrusion and the second flexible protrusion being connected onto the flexible saddle strip;
the first flexible protrusion and the second flexible protrusion being positioned opposite to each other along the flexible saddle strip;
the first flexible protrusion being rotatably connected to the first free end; and
the second flexible protrusion being rotatably connected to the second free end.

14. The bite-indicating rod holder as claimed in claim 12 comprising:
the butt stabilizer comprising a stabilizer body and a butt-bracing crevice;
the stabilizer body comprising a top body side and a bottom body side;
the stabilizer body being made of an elastic compressible material;
the top body side being connected onto the bottom platform face, adjacent to the second widthwise edge;
the butt-bracing crevice traversing from the bottom body side into the stabilizer body; and
the butt-bracing crevice being positioned parallel to the rod-orienting direction of the rod clamp.

15. The bite-indicating rod holder as claimed in claim 12 comprising:
the line-based trigger further comprising a stopping arm and a height-adjustable stop;
the stopping arm comprising a proximal arm end and a distal arm end;
the proximal arm end being laterally connected to the trigger lever, adjacent to the proximal lever end;
the stopping arm being oriented at an acute angle with the trigger lever;
the height-adjustable stop being integrated through the elongated platform;
the height-adjustable stop being positioned along the second lengthwise edge, offset from the first widthwise edge; and
the height-adjustable stop being operatively coupled to the distal arm end, wherein the highlight-adjustable stop is used to restrict movement of the distal arm end and to consequently adjust a line tension with the trigger lever.

16. The bite-indicating rod holder as claimed in claim 12 comprising:
the line-based trigger further comprising a magnetic lever catch;
the trigger lever being made of a ferromagnetic material;
the magnetic lever catch being connected onto the rod clamp, adjacent to the trigger lever; and
the magnetic lever catch being positioned opposite to the butt stabilizer about the rod clamp.

17. The bite-indicating rod holder as claimed in claim 12 comprising:
a magnetic latch catch;
an elongated latch;
the elongated latch comprising a proximal latch end and a distal latch end;
the elongated latch being made of a ferromagnetic material;
the magnetic latch catch and the elongated latch being positioned adjacent to the second lengthwise edge;
the proximal latch end being torsionally connected to the proximal lever end through the alarm system; and
the magnetic latch catch being connected onto the top platform face, offset from the proximal latch end.

18. The bite-indicating rod holder as claimed in claim 12 comprising:
the anchoring mechanism comprising a female fastener, a male fastener, a bendable arm, and a support clamp;
the support clamp being terminally mounted to the bendable arm;
the male fastener being terminally mounted to the bendable arm, opposite to the support clamp;
the female fastener being laterally integrated into the rod clamp, adjacent to the first lengthwise edge; and
the male fastener being threadably engaged into the female fastener.

19. The bite-indicating rod holder as claimed in claim 18, wherein the bendable arm is a series of interconnected ball-and-socket joints.

20. The bite-indicating rod holder as claimed in claim 12 comprising:
the alarm system comprising a housing, a controller, a speaker, an illumination device, at least one user control, and a portable power source;
the controller, the speaker, and the portable power source being mounted within the housing;
the at least one user control and the illumination device being externally mounted to the housing;
the line-based trigger traversing into the housing;
the speaker, the illumination device, the at least one user control, and the line-based trigger being electronically connected to the controller; and
the speaker, the illumination device, and the controller being electrically connected to the portable power source.
